(19) United States
(12) Patent Application Publication
(10) Pub. No.: US 2004/0103392 A1
(43) Pub. Date: May 27, 2004

(54) Saving and retrieving archive data

(76) Inventor: Guimei Zhang, Bad Schoenborn (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/306,764

(22) Filed: Nov. 26, 2002

(51) Int. Cl. G06F 9/44

(52) U.S. Cl. 717/122; 717/123; 717/163; 717/108

(57) ABSTRACT

Methods and apparatus, including computer program products, implementing and using techniques for archiving data. A request is received that specifies application data to be archived. Customizing data that is associated with a computer software application in which the specified application data was created is retrieved. The specified application data and the customizing data are stored in a data archive. Methods and apparatus, including computer program products, implementing and using techniques for displaying archive data are also presented.

### BACKGROUND

This invention relates to saving and retrieving data. Software applications running on a computer typically communicate with some type of database over a network to obtain data to be displayed to a user or otherwise processed. This is particularly common in situations where multiple applications need to have access to the same set of data. Due to technical or legal requirements, data that is not frequently accessed or used is periodically grouped together into an archive object. The archive object is then stored in a data archive, typically in a format that requires little storage space (for example, in one or more tables) so as to use the data archive as efficiently as possible. The data in the archive objects can be accessed at some later point in time as read-only data, if needed.

When a user desires to view data that has been archived, the software application or system environment may have changed after the data was archived. Therefore, the archived data is typically, instead, displayed using a software application that is different from the application that was used to create the data. In some cases the application for displaying archived data is much less sophisticated than the application in which the data was originally created. Typically, the archived data is displayed as a simple list or a table. A user that requires access to archived data can be the same user who initially created the data. The user may be confused viewing the data using the simplified archiving application instead of the original software application in which the data was created, especially if the user has to search for a particular subset of the archived data.

### SUMMARY

In general, in one aspect, this invention provides methods and apparatus, including computer program products, implementing and using techniques for archiving data. A request is received that specifies application data to be archived. Customizing data that is associated with a computer software application in which the specified application data was created is retrieved. The specified application data and the customizing data are stored in a data archive.

Advantageous implementations can include one or more of the following features. User input specifying application data to be archived can be received. Retrieving customizing data can include retrieving data specifying a context in which the specified application data was created. Storing the specified application data and the customizing data can include grouping the specified application data and the customizing data into an archive object and storing the archive object onto a tangible storage medium. The specified application data can be deleted from an original storage location.

In general, in another aspect, this invention provides methods and apparatus, including computer program products, implementing and using techniques for displaying archived application data. A request is received, the request specifying archived application data to be retrieved. The specified application data is retrieved. Customizing data that is associated with the specified application data is retrieved. The customizing data is used to create a view that looks the same as a view in which the application data was originally created the specified archived application data is displayed using the created view.

Advantageous implementations can include the following feature. The application data and the customizing data can be returned to the data archive.

The invention can be implemented to realize one or more of the following advantages. A user-friendly interface can be created, in which users can see not only current data, but also archived data in the environment in which the data was originally created. The ability to read archived data directly from the data archive, without using a simplified software application, makes retrieval of archived data faster than for systems where the data first has to be read into a database and then retrieved from that location. By designing software applications with this in mind, no software applications need to be developed for the sole purpose of showing archived data, which leads to more rapid software application development and easier maintenance of the software application.

### DESCRIPTION OF DRAWINGS

FIG. 1 shows a system for saving and retrieving archived data from a data archive.

FIG. 2 is a flowchart showing a method for archiving data along with customizing data.

FIG. 3 is a flowchart showing a method for displaying archived data to a user.

FIG. 4A is a screenshot of an interface for displaying a delivery archive objects in a data archive.

FIG. 4B is a screenshot of a prior art interface for displaying data contained in a delivery archive object in a data archive.

FIG. 4C is a screenshot of an interface for displaying data contained in a delivery archive object in a data archive along with context information.

FIG. 5A is a screenshot of an interface for displaying shipment archive objects in a data archive.

FIG. 5B is a screenshot of a prior art interface for displaying data contained in a shipment archive object in a data archive.

FIG. 5C is a screenshot of an interface for displaying data contained in a shipment archive object in a data archive along with context information.

Like reference symbols in the various drawings indicate like elements.

### DETAILED DESCRIPTION

For the purpose of this specification, it is necessary to distinguish between two different types of data; customizing data and application data. Customizing data is data that contains specific information about company structure and business rules for a given company. The customizing data contains settings, typically related to a particular company's organization, that are defined by a system administrator when implementing a computer software application or a system for a particular company or administrative entity. Customizing data is rarely changed. Application data, on the other hand, is data that is typically entered by an end user using a software application. Examples of application data is data associated with invoices, transports, sales orders, purchase orders, all of which are typically created for specific situations.

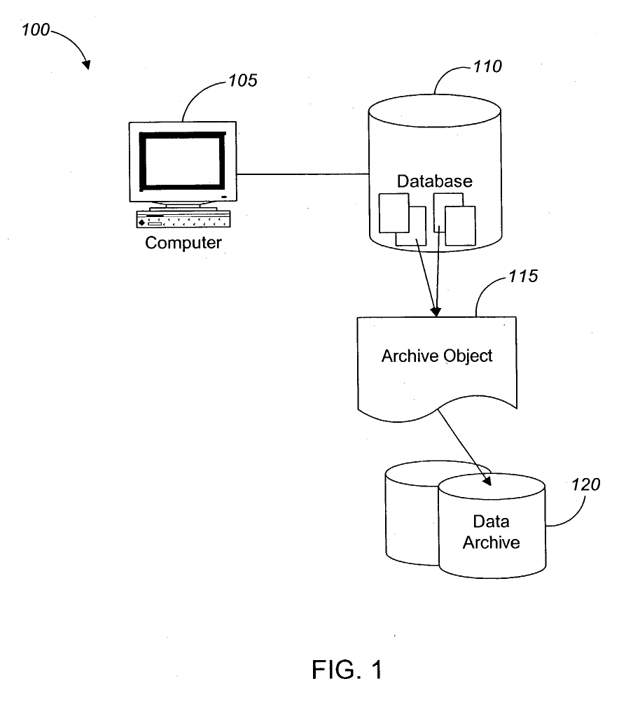

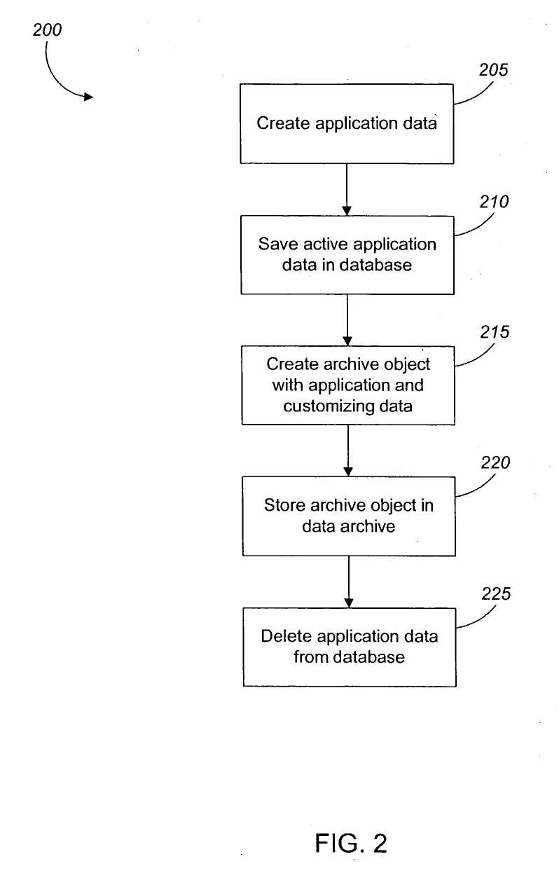

A process (200) for archiving data will now be explained with reference to FIG. 1 and FIG. 2. The process begins with application data being created (step 205) in a software application running on a computer (105). The software application has been configured for a particular user role or a particular company. The user-created application data can, for example, be the result from user input of application data, such as text or numbers, or be read as a result of a query to another software application. When the application data has been created or otherwise entered, the application data is saved in a database (110) (step 210), where the application data resides until next time the application data needs to be accessed by the computer (105).

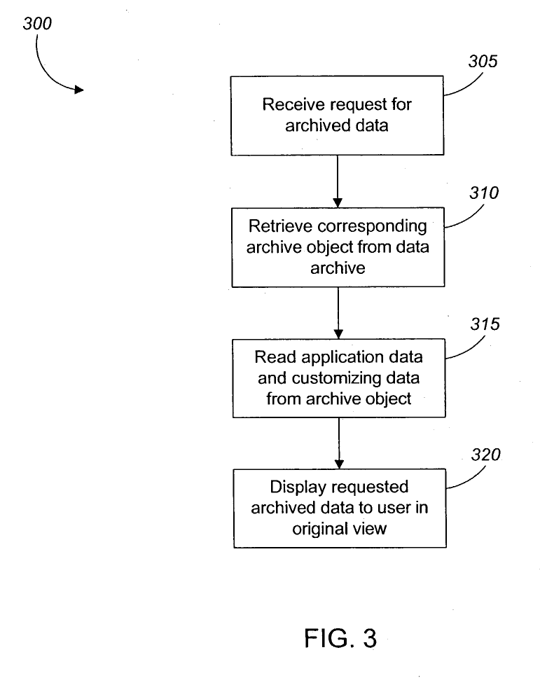

After some time, parts of the data in the database (110) require archiving (for example, the data do not have to reside in the database (110) any longer). The process groups the application data and customizing data for the application in which the application data was created together into an archive object (115) (step 215). Just like the application data, the customizing data is stored in a database from which it can be obtained by conventional methods. The process then saves the completed archive object (115) in a data archive (120) (step 220) and deletes the application data corresponding to the archived data from the database (110) (step 225), which ends the process. This results in increased storage space in the database (110) and improved performance in the computer software application. The archived data is available for retrieval from the archive and for display. How archived data is retrieved and displayed will now be shown with reference to FIG. 1 and FIG. 3.

A process (300) for retrieving and displaying archived data begins with receiving a request to display archived data in a computer program application running on a computer (105) (step 305). The request can, for example, be a user request, or be received as a request from another software application, and so on. The process then retrieves the-archive object (115) containing the requested data from the data archive (120) (step 310) and reads the content of the archive object (115) (step 315). As was described above, the content of the archive object (115) includes not only application data, but also customizing data. Finally, the customizing data is used by the software application to present the application data to the user in the same way that the application data was displayed when the data was originally created (step 320).

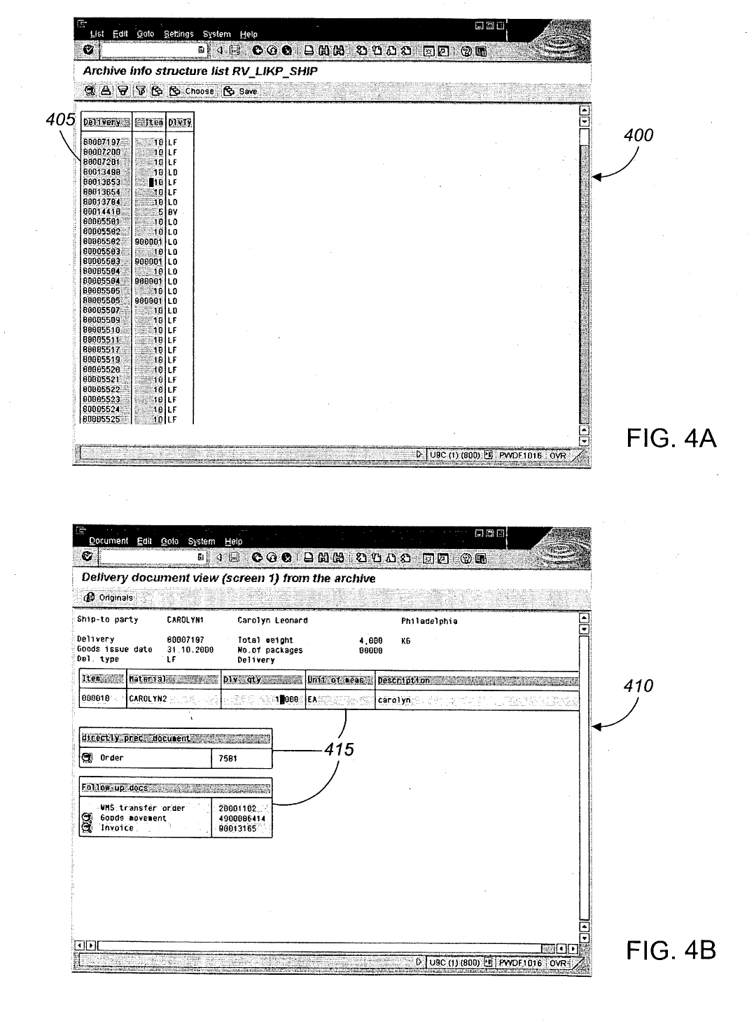

FIG. 4A shows a screenshot (400) of an interface for displaying delivery archive objects that have been archived. The set of delivery archive objects are shown as a list (405), wherein each list item corresponds to an archive object. Each archive object is identified by a delivery number, a position, and a delivery type.

When an archive object is selected from the list, it is opened so that its application data content can be viewed. A typical prior art screenshot (410) for viewing the selected data is shown in FIG. 4B, where the data contained in the selected delivery archive object is shown as entries in one or more tables (415). On the other hand, FIG. 4C shows a screenshot (420) of the data contained in the selected delivery archive object in a view that the same or similar to the view in which the data was originally created. This view is created as described above with reference to FIG. 3, using customizing data that was stored in the archive object together with the application data. As can be seen from FIGS. 4B and 4C, the two views are very different, and a user who is already familiar with the view in FIG. 4C from the time the original data was created, will likely find this view easier to use.

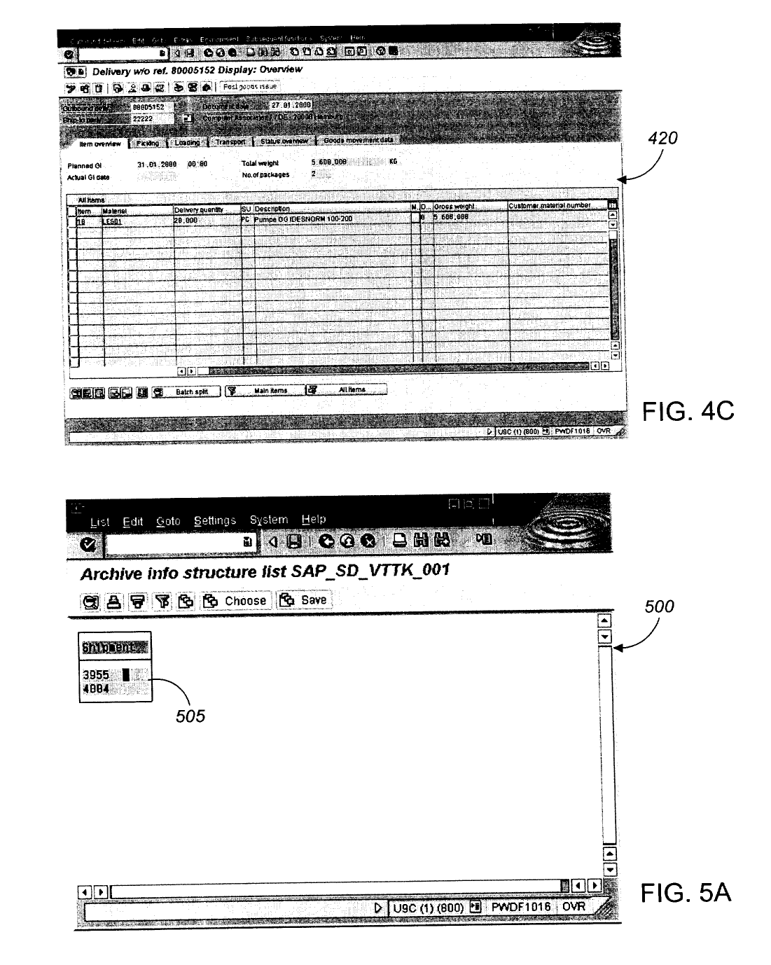

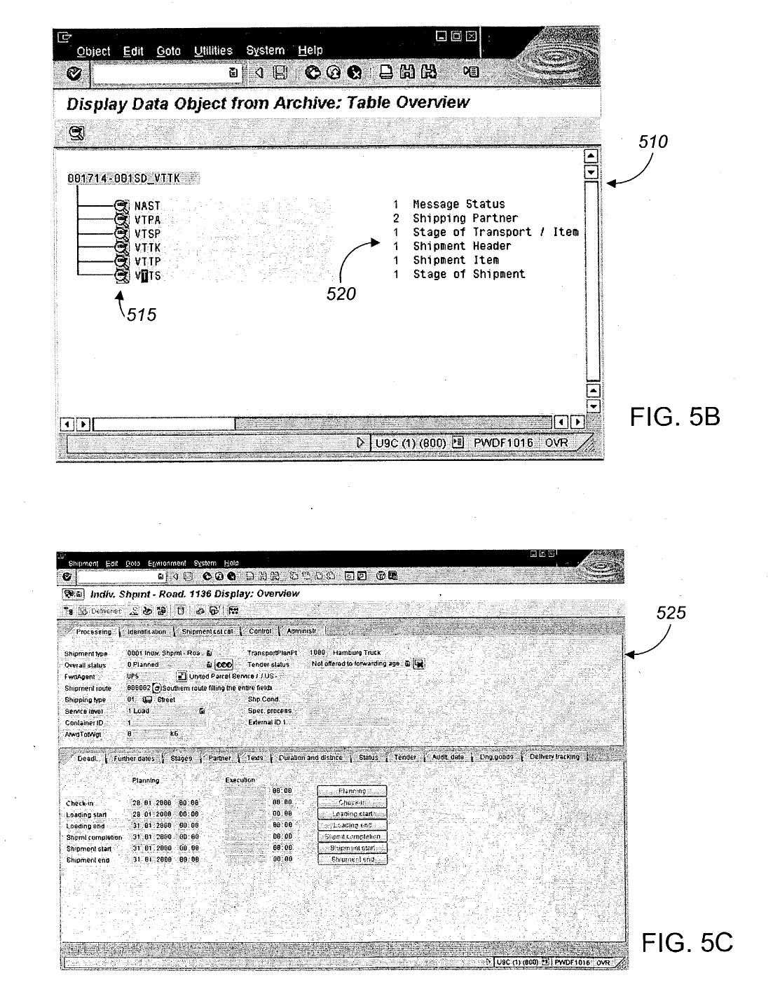

FIG. 5A shows a screenshot (500) of an interface for displaying of a set of shipment archive objects that have been archived in a data archive. Similarly to the screenshot shown in FIG. 4A, the set of shipment archive objects are shown as a list (505), wherein each list item corresponds to an archive object.

Again, when an archive object is selected from the list, it is opened so that its application data content can be viewed. A typical prior art screenshot (510) for viewing the selected data is shown in FIG. 5B, where the data contained in the selected shipment archive object is shown as a list (515) with explanations (520) of the list entries. FIG. 5C shows a screenshot (525) of the data contained in the selected freight calculation archive object in a view that looks same or similar to the view in which the data was originally created. Again, this view is created using the process described above with reference to FIG. 3. As can be seen from FIG. 5B and FIG. 5C, the two views are very different, and a user who is already familiar with the view in FIG. 5C from the time the original data was created, will likely find this view easier to use.

The invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs (application-specific integrated circuits).

To provide for interaction with a user, the invention can be implemented on a computer system having a display device such as a monitor or LCD screen for displaying information to the user and a keyboard and a pointing device such as a mouse or a trackball by which the user can provide input to the computer system. The computer system can be programmed to provide a graphical user interface through which computer programs interact with users.

A number of embodiments of the invention have been described. Nevertheless, it will be understood that various modifications may be made without departing from the spirit and scope of the invention. For example the principles discussed above can be applied to a wide variety of different software applications and types of application data, such as sales orders, purchasing orders, billing documents, financial accounting documents, and so on. Accordingly, other embodiments are within the scope of the following claims.

What is claimed is:

1. A method for archiving data, comprising:
receiving a request specifying application data to be archived;
retrieving customizing data that is associated with a computer software application in which the specified application data was created; and
storing the specified application data and the customizing data in a data archive.

2. The method of claim 1, wherein receiving a request comprises:
receiving user input specifying application data to be archived.

3. The method of claim 1, wherein retrieving customizing data comprises:
retrieving data specifying a context in which the specified application data was created.

4. The method of claim 1, wherein storing the specified application data and the customizing data comprises:
grouping the specified application data and the customizing data into an archive object; and
storing the archive object onto a tangible storage medium

5. The method of claim 1, further comprising:
deleting the specified application data from an original storage location.

6. A method for displaying archived application data, comprising:
receiving a request specifying archived application data to be retrieved;
retrieving the specified application data;
retrieving customizing data that is associated with the specified application data;
using the customizing data to create a view that looks the same as a view in which the application data was originally created; and
displaying the specified archived application data using the created view.

7. The method of claim 5, wherein receiving a request comprises:
receiving user input specifying archived application data to be retrieved.

8. The method of claim 5, wherein retrieving customizing data comprises:
retrieving data specifying a context in which the specified application data was created.

9. The method of claim 5, further comprising:
returning the application data and the customizing data to the data archive.

10. A computer program product for archiving data, comprising instructions operable to cause a programmable processor to:
receive a request specifying application data to be archived;
retrieve customizing data that is associated with a computer software application in which the specified application data was created; and
store the specified application data and the customizing data in a data archive.

11. The computer program product of claim 10, wherein the instructions to receive a request comprise instructions to:
receive user input specifying application data to be archived.

12. The computer program product of claim 10, wherein the instructions to retrieve customizing data comprise instructions to:
retrieve data specifying a context in which the specified application data was created.

13. The computer program product of claim 10, wherein the instructions to store the specified application data and the customizing data comprise instructions to:
group the specified application data and the customizing data into an archive object; and
store the archive object onto a tangible storage medium.

14. The computer program product of claim 10, further comprising instructions to:
delete the specified application data from an original storage location.

15. A computer program product for displaying archived application data, comprising instructions operable to cause a programmable processor to:
receive a request specifying archived application data to be retrieved; retrieve the specified application data;
retrieve customizing data that is associated with the specified application data;
use the customizing data to create a view that looks the same as a view in which the application data was originally created; and
display the specified archived application data using the created view.

16. The computer program product of claim 15, wherein the instructions to receive a request comprise instructions to:
receive user input specifying archived application data to be retrieved.

17. The computer program product of claim 15, wherein instructions to retrieve customizing data comprise instructions to:
retrieve data specifying a context in which the specified application data was created.

18. The computer program product of claim 15, further comprising instructions to:
return the application data and the customizing data to the data archive.
